(19) United States
(12) Patent Application Publication
(10) Pub. No.: US 2026/0148547 A1
(43) Pub. Date: May 28, 2026

(54) DRONE INSPECTION SYSTEM AND AUTOMATIC INSPECTION METHOD

(71) Applicant: Wistron Corporation, New Taipei City (TW)

(72) Inventors: Shao Huan Chen, New Taipei City (TW); Chun Wei Wu, New Taipei City (TW); Wensen Lee, New Taipei City (TW)

(73) Assignee: Wistron Corporation, New Taipei City (TW)

(21) Appl. No.: 19/002,785

(22) Filed: Dec. 27, 2024

(30) Foreign Application Priority Data
Nov. 25, 2024 (TW) 113145330

(51) Int. Cl. G06V 20/17; G01C 21/20; G06T 7/00; G06T 7/50; G06T 7/70; G06V 20/10

(52) U.S. Cl. CPC G06V 20/17; G01C 21/20; G06T 7/0002; G06T 7/50; G06T 7/70; G06V 20/176; G06T 2207/10032; G06T 2207/20081; G06T 2207/30184

(57) ABSTRACT

The present invention provides a drone inspection system that includes a server and a drone. The server receives an inspection task through an operating interface. The inspection task includes an inspection route. The drone is equipped with an image capture module. The server executes a schedule to set the drone for carrying out the inspection task. The image capture module continuously captures multiple environmental images, and the drone identifies its position based on these images to move on the inspection route. As the drone proceeds along the inspection route, it transmits the environmental images to the server. The server then determines whether an abnormal phenomenon has occurred based on the environmental images and generates an inspection result corresponding to the inspection task.

### CROSS-REFERENCE TO RELATED APPLICATION

This application claims the priority benefit of Taiwan application serial no. 113145330, filed on Nov. 25, 2024. The entirety of the above-mentioned patent application is hereby incorporated by reference herein and made a part of this specification.

### BACKGROUND

### Technical Field

The present disclosure relates to a drone inspection system and an automatic inspection method capable of automatically executing inspection tasks.

### Related Art

In the existing technology, drones are widely applied to various inspection tasks, especially in dangerous or difficult-to-reach environments, such as high-voltage towers, petrochemical equipment, and structural inspections after natural disasters. Drones may perform effective inspections in these environments, assisting in examining whether equipment has structural abnormalities or damage. However, current drone inspection technology still has several limitations, one of which is the need for operators to closely follow the drone to continuously control the flight path and task execution during operation. Moreover, in many stages, manual intervention by personnel is still required in the data collection and processing to ensure data integrity and accuracy. When related units want to perform inspection tasks, there is also a lack of a unified system to manage these inspection tasks.

### SUMMARY

The present disclosure proposes a drone inspection system and an automatic inspection method that may solve the drawbacks of known human-controlled drone inspection tasks.

The present disclosure proposes a drone inspection system, including a server and a drone. The server is used to provide an operation interface and receive inspection tasks through the operation interface, wherein the inspection task includes an inspection route. The drone is communicatively connected to the server. The drone includes an image capture module. The server executes a schedule to set the drone to perform the inspection task. The image capture module continuously obtains multiple environmental images, and the drone recognizes its position based on the environmental images to travel on the inspection route. In response to the drone traveling on the inspection route, the drone sends the environmental images to the server, and the server determines whether an abnormal phenomenon occurs based on the environmental images to generate inspection results corresponding to the inspection task.

In an embodiment of the present disclosure, the aforementioned drone also sends the drone's speed, height, and position to the server. The server determines whether the drone's travel route complies with the inspection route. In response to the travel route not complying with the inspection route, the server terminates the inspection task.

In an embodiment of the present disclosure, the aforementioned inspection route is a tunnel, and the drone detects a track and a sidewall in the environmental images to calculate a first distance between the drone and the track and a second distance between the drone and the sidewall. The drone is controlled to be positioned at the center of the tunnel according to the first distance and the second distance.

In an embodiment of the present disclosure, the aforementioned server predicts the signal intensity of the inspection route according to a machine learning model. In response to the signal intensity in an area of the inspection route being lower than a threshold, the server reduces the speed of the drone in the area.

In an embodiment of the present disclosure, the aforementioned inspection result includes the type and location of the abnormal phenomenon. The type include cracks, water seepage, or track distortion.

In an embodiment of the present disclosure, in response to the server determining that an abnormal phenomenon has occurred, the server controls the drone to hover, sends out a warning message, and receives a reply message from an external device. The server determines whether to control the drone to continue the inspection task according to the reply message.

From another perspective, an embodiment of the present invention proposes an automatic inspection method, applicable to a server and a drone. The drone includes an image capture module. The automatic inspection method includes: receiving an inspection task through an operation interface provided by the server, wherein this inspection task includes an inspection route; executing a schedule to set the drone to perform the inspection task, wherein the image capture module is used to continuously obtain multiple environmental images; the drone recognizing its position based on the environmental images to travel on the inspection route; in response to the drone traveling on the inspection route, the drone sending the environmental images to the server; and the server determining whether an abnormal phenomenon occurs based on the environmental images to generate inspection results corresponding to the inspection task.

In an embodiment of the present disclosure, the automatic inspection method further includes: sending the drone's speed, height, and position to the server which determines whether the drone's travel route complies with the inspection route; and in response to the travel route not complying with the inspection route, terminating the inspection task.

In an embodiment of the present disclosure, the aforementioned inspection route is a tunnel, and the inspection method further includes: the drone detecting a track and a sidewall in the environmental images to calculate a first distance between the drone and the track and a second distance between the drone and the sidewall; and controlling the drone to be positioned at the center of the tunnel according to the first distance and the second distance.

In an embodiment of the present disclosure, the aforementioned automatic inspection method further includes: predicting, by the server, the signal intensity of the inspection route according to a machine learning model; and in response to the signal intensity in an area of the inspection route being lower than a threshold, reducing the speed of the drone in this area.

In an embodiment of the present disclosure, the aforementioned automatic inspection method further includes: in response to the server determining that an abnormal phenomenon has occurred, the server controls the drone to hover, sends out a warning message, and receives a reply message from an external device; and determining whether to control the drone to continue the inspection task according to the reply message.

To make the above-mentioned features and advantages of the present invention more apparent and understandable, exemplary embodiments are described below with reference to the accompanying drawings in detail as follows.

### BRIEF DESCRIPTION OF THE DRAWINGS

FIG. 1 is a schematic diagram illustrating a drone inspection system according to an embodiment.

FIG. 2 is a schematic diagram illustrating drone position recognition according to an embodiment.

FIG. 3 is a schematic diagram illustrating signal intensity within a certain area according to an embodiment.

FIG. 4 is a flowchart illustrating the response process when an abnormal phenomenon is detected according to an embodiment.

FIG. 5 is a flowchart illustrating an automatic inspection method according to an embodiment.

### DESCRIPTION OF THE EMBODIMENTS

Some embodiments of the present invention will be described in detail below with reference to the accompanying drawings. In the following description, when the same reference numerals appear in different drawings, they will be considered as the same or similar components. These embodiments are only a part of the present invention and do not disclose all possible implementations of the present invention. More precisely, these embodiments are examples of the systems and methods within the scope of the patent claims of the present invention.

Regarding the terms “first,” “second,” etc. used in this document, they do not specifically indicate order or sequence, but are merely used to distinguish components or operations described with the same technical terms.

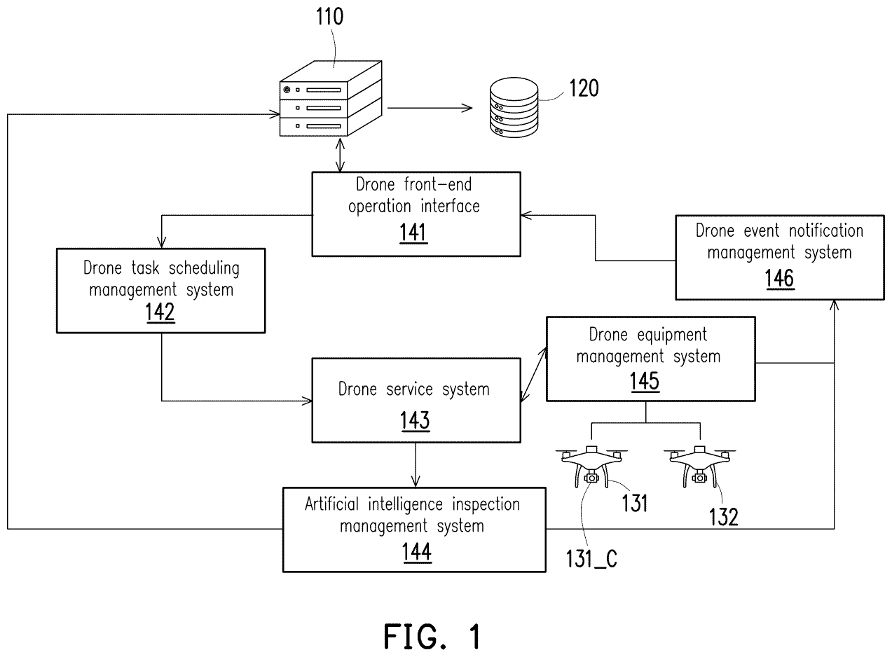

FIG. 1 is a schematic diagram illustrating a drone inspection system according to an embodiment. Referring to FIG. 1, the drone inspection system includes a server 110 and multiple drones 131, 132. Each drone 131, 132 is equipped with at least one image capture module (e.g., image capture module 131_C), a communication module, or other sensors (e.g., accelerometer, positioning system, or height sensor) to obtain information such as its own speed, height, etc.

The server 110 is electrically connected to a database 120 and executes multiple interfaces and systems, which may include software or hardware. The interfaces and systems mentioned below are only examples; in other embodiments, one system may be divided into multiple subsystems, or multiple systems may be integrated together. In this embodiment, the server 110 provides a drone front-end operation interface 141 (also referred to as operation interface), and executes a drone task scheduling management system 142, a drone service system 143, an artificial intelligence inspection management system 144, a drone equipment management system 145, and a drone event notification management system 146. The drone inspection system provides a unified operation interface, allowing personnel from different departments or organizations to input inspection tasks. The drone inspection system will automatically schedule, dispatch drones to execute inspection tasks, detect any abnormal phenomena, and finally generate inspection results. These inspection results may be stored in the database 120, and relevant personnel may browse or analyze these inspection results through the operation interface. The functions of these interfaces and systems will be explained below.

The drone front-end operation interface 141 is used to provide relevant personnel with the ability to input and manage inspection tasks, and the server 110 receives inspection tasks through this operation interface. Relevant personnel may use suitable devices to run browsers, mobile applications, or computer software to use this drone front-end operation interface 141. Relevant personnel may set up regular inspection tasks (e.g., daily or weekly), or set up irregular inspection tasks (e.g., arranging an inspection task when a specific event occurs). Inspection tasks include date, inspection route, designation of a specific drone, etc. In some embodiments, this system is used in a subway system, where the inspection route includes a tunnel, and the tunnel includes a track. However, in other embodiments, the drone inspection system may also be used in any suitable location such as at sea and construction sites, which is not limited in the present invention. In some embodiments, relevant personnel may also view inspection results through this operation interface.

The drone equipment management system 145 is used to establish communication connections with the drones 131, 132 for sending and receiving data. In some embodiments, the drone equipment management system 145 exchanges data through an Application Programming Interface (API), which may include structured files or unstructured files. The structured files, such as JavaScript Object Notation (JSON), are used to store relational database data such as flight information including height, speed, position, etc. The unstructured files include video streams and photos. The API allows the drones 131, 132 to synchronize with the server 110, enabling the drones 131, 132 to obtain system information from the server 110, including Message Queuing Telemetry Transport (MQTT) paths (used for transmitting aircraft information) and Real Time Messaging Protocol (RTMP) paths (used for transmitting video streams). The data received by the drone equipment management system 145 may be stored in the database 120 for future retrieval and verification. In some embodiments, the communication between the drone equipment management system 145 and the drones 131, 132 uses Transport Layer Security (TLS)/Secure Sockets Layer (SSL) protocols for transmission to prevent data from being intercepted or tampered with during transmission.

The drone task scheduling management system 142 has at least two major functions: task assignment and task route setting. The task assignment is used to execute a schedule according to the set inspection tasks, thereby determining which drone performs which inspection task at what time. The Task route setting is used to pre-set inspection routes for the drones 131, 132 according to the route data provided by the server 110, avoiding errors in drone inspection tasks caused by human scheduling mistakes.

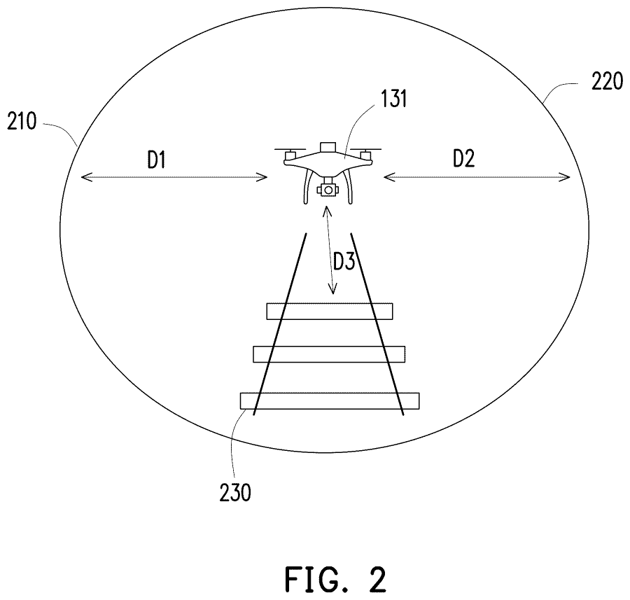

The drone service system 143 is used to monitor the status, flight path, video stream transmission status, etc. of the drones 131, 132 in real-time. The status of the drones 131, 132 includes position, height, speed, battery level, etc. Taking the drone 131 as an example, during the process of executing an inspection task, the drone 131 continuously obtains multiple environmental images. The drone identifies its own position to travel along the inspection route based on these environmental images. For example, FIG. 2 is a schematic diagram illustrating drone position identification according to an embodiment. The aforementioned inspection route is a tunnel, which has sidewalls 210, 220 and is equipped with a track 230. In some embodiments, there are markers on the track 230, with numbers on the markers indicating the distance between the marker and the starting point (or endpoint). The drone 131 may identify these markers to confirm its position. In some embodiments, the drone 131 may also identify the track 230 and the sleepers beneath the track, thereby continuing to move along the track and calculating its current position by counting the sleepers, until it reaches the end of track 230 and then returns to the starting point. Additionally, the drone 131 detects the sidewalls 210, 220 and the track 230 in the environmental images, thereby calculating the distance D3 between the drone 131 and the track 230, as well as the distances D1, D2 between the drone 131 and the sidewalls 210, 220. The drone 131 controls itself to be at the center of the tunnel based on these distances D1˜D3, for example, by making the distance D1 equal to the distance D2, and setting the distance D3 within a certain range, to avoid colliding with the sidewalls 210, 220 or flying too low and hitting other obstacles.

In some embodiments, the drone 131 sends its speed, height, and position to the drone service system 143. The drone service system 143 determines whether the travel route of the drone 131 complies with the pre-set inspection route. If the travel route of drone 131 does not comply with the inspection route, the drone service system 143 may terminate the inspection task, reset the inspection route, or re-plan the travel route for the drone 131. For example, if there is an obstacle on the inspection route, and the drone 131 deviates from the inspection route to avoid the obstacle, the drone service system 143 may reset the inspection route according to the current environmental conditions and the inspection task, ensuring that drone 131 can avoid the obstacle and complete the task according to the new inspection route.

In some embodiments, the communication between the server 110 and the drone 131 is conducted through 5G mobile network (also known as cellular network) or other high-speed wireless communication technology. The drone service system 143 also monitors the communication signal intensity, latency, and data integrity (whether there are lost packets or unrecoverable errors) in real-time. If phenomena such as video stream interruption or excessive delay occur, the drone service system 143 may also interrupt the inspection task.

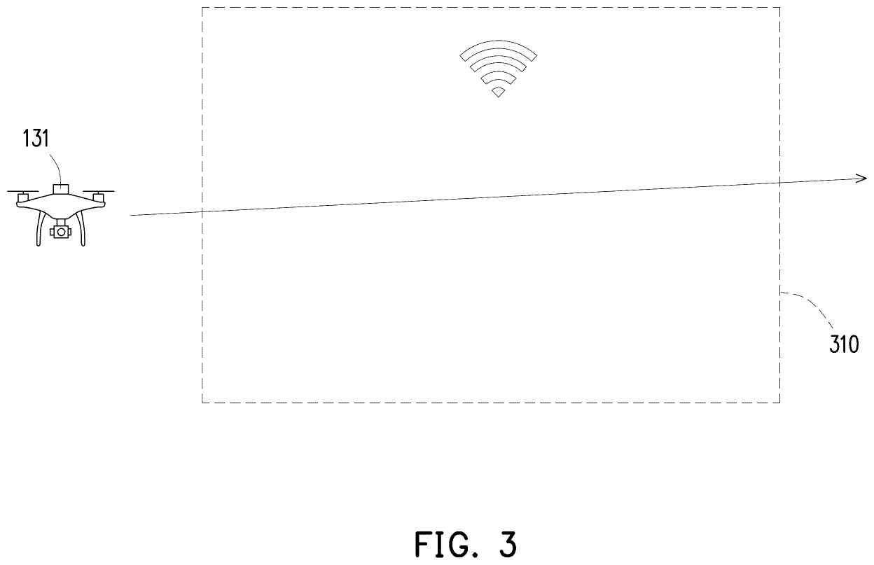

In some embodiments, the drone 131 flies back and forth in the tunnel, thus passing through the same area multiple times, and the signal intensity of this area each time it passes can be collected. The drone service system 143 may predict the signal intensity on the inspection route according to a machine learning model. When the predicted signal intensity is lower than a threshold, the speed of the drone 131 is reduced in this area. FIG. 3 is a schematic diagram illustrating the signal intensity within a certain area according to an embodiment. Please refer to FIG. 3, the drone service system 143 may collect historical signal intensities within an area 310, and then input these historical signal intensities into a machine learning model, such as Long Short-Term Memory (LSTM), to predict future signal intensities. When the predicted signal intensity within the area 310 is lower than the threshold, the speed of drone 131 passing through this area 310 will be reduced. This is to avoid damage to the drone 131 due to insufficient reaction time in case of abnormal conditions.

Referring to FIG. 2, the artificial intelligence inspection management system 144 is used to execute a machine learning model to determine whether there are abnormal phenomena. Specifically, the environmental images captured by the drone 131 are transmitted to the artificial intelligence inspection management system 144. The machine learning model may be decision tree, random forest, multi-layer perception (MLP), convolutional neural network, support vector machine, etc., which is not limited in the present invention. In some embodiments, the types of abnormal phenomena include cracks, water seepage, or track distortion, but the present invention is not limited thereto. When an abnormal phenomenon occurs, the artificial intelligence inspection management system 144 also records the location of the abnormal phenomenon, and then writes both the location and type into the database 120. After the drone 131 completes the inspection task, the server 110 generates an inspection result. This inspection result includes whether an abnormal phenomenon has occurred, and information such as the type and location of the abnormality if there is an abnormal phenomenon. The inspection result also includes information such as the inspection route, time, drone that executed the task, and related environmental images. Relevant personnel may browse or analyze these inspection results through the drone front-end operation interface 141.

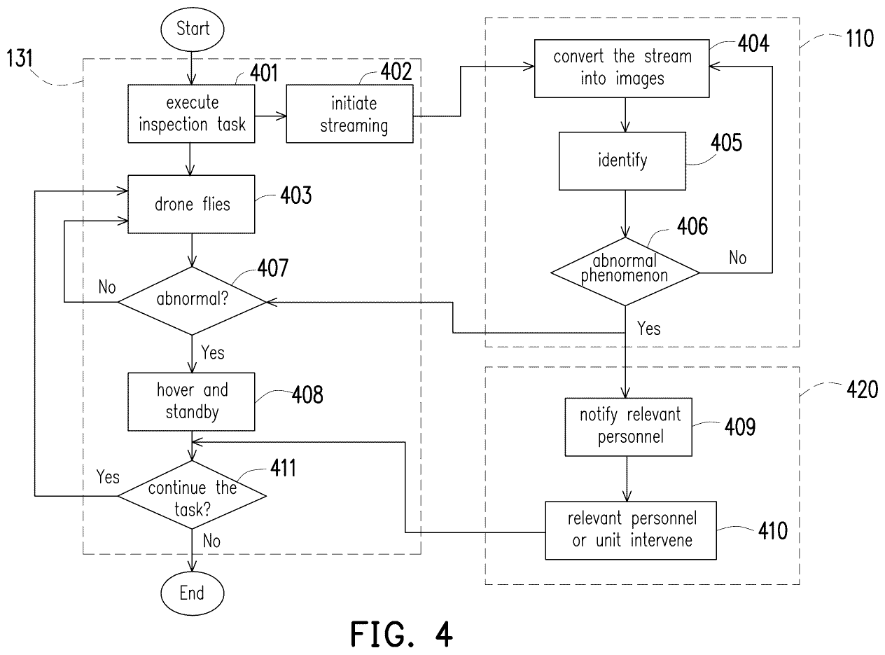

FIG. 4 is a flow chart illustrating the response process when an abnormal phenomenon is detected according to an embodiment. Referring to FIG. 1 and FIG. 4. At step 401, the drone 131 executes the inspection task. At step 402, the drone 131 initiates streaming and sends the stream to the server 110. Simultaneously at step 403, the drone 131 flies along the inspection route. At step 404, the server 110 converts the stream into images (referred to as environmental images). At step 405, the server 110 identifies abnormal phenomena in these environmental images. Next, at step 406, it is determined whether there is an abnormal phenomenon. If not, the process returns to step 404 to continue processing subsequent streams. If there is an abnormal phenomenon, the server 110 controls the drone 131 to hover, land, or directly end the inspection task and return. For example, at step 407, the drone determines whether it has received instructions from the server 110, which are used to indicate whether there is an abnormal phenomenon. If there is no abnormal phenomenon, the drone 131 returns to step 403 to continue flying. If there is an abnormal phenomenon, the drone 131 executes step 408 to hover and standby (or it may also land).

On the other hand, the server 110 sends a warning message to an external device 420 through the drone event notification management system 146. This warning message may be provided to the external device 420 in various forms such as e-mail, messages in applications or web pages, text messages, etc. At step 409, the external device 420 notifies relevant personnel to check this warning message. At step 410, the relevant personnel or units intervene to determine whether the drone 131 should continue the inspection task. Then, the external device 420 provides a reply message to the server 110, and the server 110 determines whether to control the drone 131 to continue the inspection task according to this reply message (for simplification, an arrow is drawn from step 410 to the drone 131 in FIG. 4 because at this point it is essentially the external device 420 that decides whether to continue the inspection task). At step 411, the drone 131 determines whether to continue the inspection task according to the reply message. If so, it returns to step 403; otherwise, this process ends.

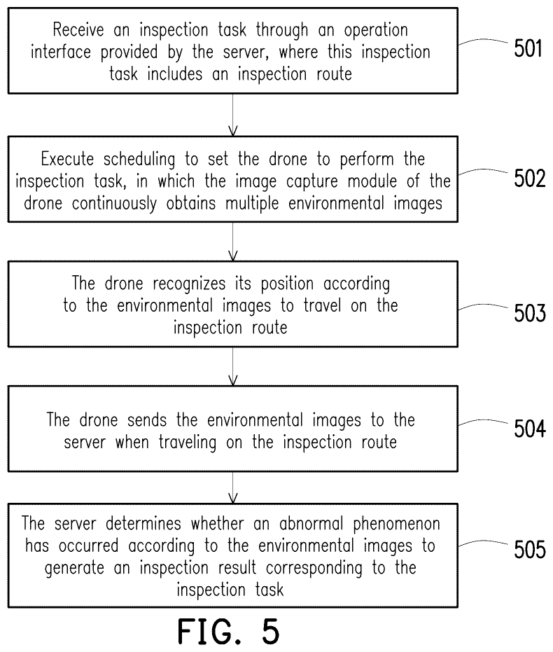

FIG. 5 is a flow chart illustrating an automatic inspection method according to an embodiment. At step 501, an inspection task is received through an operation interface provided by the server, where this inspection task includes an inspection route. At step 502, a schedule is executed to set the drone to perform the inspection task, in which the image capture module of the drone continuously obtains multiple environmental images. At step 503, the drone recognizes its position according to the environmental images to travel on the inspection route. At step 504, the drone sends the environmental images to the server when traveling on the inspection route. At step 505, the server determines whether an abnormal phenomenon has occurred according to the environmental images to generate an inspection result corresponding to the inspection task. Each step in FIG. 5 has been explained in detail as above, so these explanations will not be repeated here. It is worth noting that each step in FIG. 5 may be implemented as multiple codes or circuits, and the present invention is not limited to this. Moreover, the method of FIG. 5 may be used in conjunction with the above embodiments or used independently. In other words, other steps may also be added between the steps of FIG. 5.

In the above-mentioned system and method, a unified operation interface is provided for personnel from various units to set inspection tasks, solving the known problem of setting tasks and schedules manually. On the other hand, since the Global Positioning System (GPS) cannot be used in locations such as tunnels, in the above embodiments, positioning is done by images captured by the drone. After completing the inspection task, the drone will automatically return to base, which also avoids having operators move along with the drone. Finally, the above system and method use artificial intelligence models to automatically determine abnormal phenomena. All judgment results and relevant data of the drone are stored in the database, and relevant personnel may view these data through the operation interface.

Although the present invention has been disclosed by the above embodiments, it is not intended to limit the present invention. Any person skilled in the art may make some modifications and refinements without departing from the spirit and scope of the present invention. Therefore, the protection scope of the present invention should be defined by the appended claims.

What is claimed is:

1. A drone inspection system, comprising:
a server, configured to provide an operation interface, and to receive an inspection task through the operation interface, wherein the inspection task including an inspection route; and
a drone, communicatively connected to the server, wherein the drone comprises an image capture module,
wherein the server is configured to execute a schedule to set the drone to execute the inspection task, the image capture module is configured to continuously obtain a plurality of environment images, and the drone is configured to recognize a position of the drone according to the environment images to travel on the inspection route,
wherein in response to the drone travelling on the inspection route, the drone is configured to send the environment images to the server, the server is configured to determine whether an abnormal phenomenon occurs according to the environment images to generate an inspection result corresponding to the inspection task.

2. The drone inspection system as claimed in claim 1, wherein the drone further sends speed, height, and the position of the drone to the server, the server is configured to determine whether a travel route of the drone complies with the inspection route,
wherein in response to the travel route not complying with the inspection route, the server is configured to terminate the inspection task.

3. The drone inspection system as claimed in claim 1, wherein the inspection route is a tunnel, the drone is configured to detect a track and a sidewall in the environment images to calculate a first distance between the drone and the track and a second distance between the drone and the sidewall,
wherein the drone is configured to control the drone to be located at a central position in the tunnel according to the first distance and the second distance.

4. The drone inspection system as claimed in claim 1, wherein the server is configured to predict a signal intensity of the inspection route according to a machine learning model,
wherein in response to the signal intensity of an area in the inspection route being lower than a threshold, the server reduces a speed of the drone in the area.

5. The drone inspection system as claimed in claim 1, wherein the inspection result comprises a type and a position of the abnormal phenomenon, and the type comprises crack, water seepage or track distortion.

6. The drone inspection system as claimed in claim 1, wherein in response to the server determining that the abnormal phenomenon occurs, the server controls the drone to hover, sends out a warning message, and receives a reply message from an external device,
wherein the server is configured to determine whether to control the drone to continue the inspection task according to the reply message.

7. A method for automatic inspection for a server and a drone, wherein the drone comprises an image capture module, and the method comprises:
receiving an inspection task through an operation interface provided by the server, wherein the inspection task comprises an inspection route;
executing a schedule to set the drone to execute the inspection task, wherein the image capture module is configured to continuously obtain a plurality of environment images;
recognizing, by the drone, a position of the drone according to the environment images to travel on the inspection route;
sending, by the drone, the environment images to the server in response to the drone traveling on the inspection route; and
determining, by the server, whether an abnormal phenomenon occurs according to the environment images to generate an inspection result corresponding to the inspection task.

8. The method for automatic inspection as claimed in claim 7, further comprising:
sending speed, height, and the position of the drone to the serve, and determining, by the server, whether a travel route of the drone complies with the inspection route; and
if the travel route does not comply with the inspection route, terminating the inspection task.

9. The method for automatic inspection as claimed in claim 7, wherein the inspection route is a tunnel, the method further comprising:
detecting, by the drone, a track and a sidewall in the environment images to calculate a first distance between the drone and the track and a second distance between the drone and the sidewall; and
controlling, by the drone, the drone to be positioned at a central location in the tunnel according to the first distance and the second distance.

10. The method for automatic inspection as claimed in claim 7, further comprising:
predicting, by the server, a signal intensity of the inspection route according to a machine learning model; and
in response to the signal intensity of an area in the inspection route being lower than a threshold, reducing a speed of the drone in the area.

11. The method for automatic inspection as claimed in claim 7, wherein the inspection result comprises a type and a location of the abnormal phenomenon, and the type comprises crack, water seepage or track distortion.

12. The method for automatic inspection as claimed in claim 7, further comprising:
in response to the server determining that the abnormal phenomenon occurs, controlling, by the server, the drone to hover, sending out a warning message, and receiving a reply message from an external device; and
determining whether to control the drone to continue the inspection task according to the reply message.
